(19) United States
(12) Patent Application Publication
(10) Pub. No.: US 2014/0236232 A1
(43) Pub. Date: Aug. 21, 2014

(54) MULTI-USE PACIFIER

(71) Applicant: Charles Williams Knierim, Old Bridge, NJ (US)

(72) Inventor: Charles Williams Knierim, Old Bridge, NJ (US)

(21) Appl. No.: 14/054,045

(22) Filed: Oct. 15, 2013

Related U.S. Application Data
(63) Continuation-in-part of application No. 13/771,058, filed on Feb. 19, 2013, now abandoned.

(51) Int. Cl. A61J 17/02

(52) U.S. Cl. CPC A61J 17/02
USPC 606/235; 606/236

(57) ABSTRACT

A multi use pacifier including a teething ring, where the teething ring includes a twist top; a nipple, where the nipple includes a plurality of orifices over the surface of the nipple; a mouth guard at one end of the nipple; a receiver extending beyond the mouth guard, where the twist top attaches the ring to the pacifier; an opening in the receiver for inserting a food product; and safety tabs, where the safety tabs lock the teething ring to the nipple. The safety tabs may be placed on each side of the receiver. The receiver includes an opening that is used to insert food into the receiver and passed through to the interior of the nipple. The nipple includes a first end and tabs are provided at the first end to prevent retraction of food out of the nipple near the mouth guard.

### CROSS REFERENCE TO OTHER APPLICATIONS

This application is a continuation in part to U.S. patent application Ser. No. 13/771,058 filed on Feb. 19, 2013.

### BACKGROUND OF THE INVENTION

1. Field of Invention

The present invention relates to a multi-use pacifier that provides a means to dispense a snack.

2. Description of Related Art

Parents use various devices to soothe or comfort infants as they mature through the growing process. A pacifier is a common means to pacify and settle the infant while awake or just before going to sleep. Many pacifiers are nipple shaped with a mouth guard to prevent the accidental swallowing or choking upon the pacifier. In addition to a pacifier, parents may bottle feed the infant, principally for feeding purposes but also to temporarily appease or occupy the infant for a short period of time. Frequent use of the feeding bottle however can lead to over feeding an infant, which can cause digestion problems for the infant. As an alternative, it would be advantageous to have a means to distribute or dispense a small snack to the infant through the pacifier. The use of such a device can enhance the use of the pacifier and supply a limited to snack to the infant thus avoiding over feeding.

### SUMMARY OF THE INVENTION

The present invention relates to a multi use pacifier comprising: a teething ring, where the teething ring includes a twist top; a nipple, where the nipple includes a plurality of orifices over the surface of the nipple; a mouth guard at one end of the nipple; a receiver extending beyond the mouth guard, where the twist top attaches the ring to the pacifier; an opening in the receiver for inserting a food product; and safety tabs, where the safety tabs lock the teething ring to the nipple. The safety tabs may be placed on each side of the receiver. The receiver includes an opening that is used to insert food into the receiver and passed through to the interior of the nipple. The nipple includes a first end and tabs are provided at the first end to prevent retraction of food out of the nipple near the mouth guard.

### BRIEF DESCRIPTION OF DRAWINGS

FIG. 1 depicts a detachable ring and mouth guard used in conjunction with the present invention.

FIG. 2 depicts an expanded view of the ring, mouth guard and a pacifier that are combined for use with the present invention.

### DETAILED DESCRIPTION

The present invention relates to a multi-use pacifier for use with an infant. The pacifier includes a twist off ring that exposes a small opening on the ring side of a mouth guard. The small opening provides a means to insert a soft fruit like snack that is engorged into the inner portion of the nipple. A plurality of orifices is provided along the surface of the nipple to allow for the snack to move through the openings while the infant sucks upon the nipple. The multi-use pacifier consequently provides a small snack dispenser or a traditional pacifier in one device.

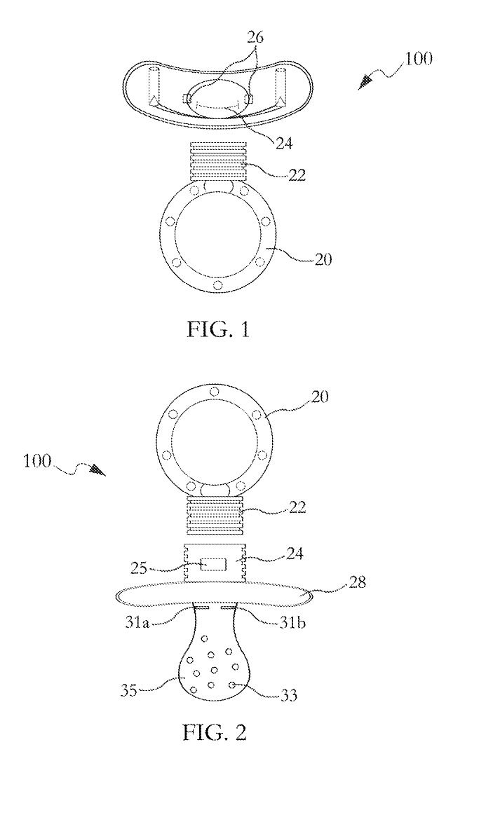

FIG. 1 depicts a ring 20 and a mouth guard 28 used in conjunction with the Pacifier 100. The ring 20 includes a twist top that is used to attach to a pacifier 35, as shown in FIG. 2. The mouth guard 28 is placed at one end of the pacifier 35 and provides a means to protect the pacifier 35 from being swallowed or accidently choking the infant during use. As depicted in FIG. 1, a receiver 24 is shown. The twist top 22 is inserted into the receiver 24 to assemble the ring 20 onto the pacifier 35. Also safety tabs 26 are provided on each side of the receiver 24. The safety tabs 26 lock the ring 20 into place once it is attached to the pacifier 35. FIG. 2 depict the components of the Pacifier 100. As shown, the ring 20 attaches to the pacifier by using the twist top 22. The twist top 22 inserts into the receiver 24. The receiver 24 includes an opening 25 that is used to insert food that enters into the receiver 24 and is passed into the interior of the nipple 35. At a first end of the nipple 35, tabs 31a, 31b are provided to prevent the retraction of food out of the nipple near the mouth guard 28. Over the surface of the nipple 35 the plurality of orifices 33 are provided that allow the movement of the food into the infant's mouth once the infant is sucking on the nipple 35. Once completely assembled the Pacifier 100 provides a means to pacify and/or feed an infant.

Food may be inserted through the opening 25, where the food can be in the form of fruit or baby-type food that is easily passed through the orifices 33 provided on the nipple 35. This pacifier 35 consequently allows two functions in one device. Further the pacifier 35 allows the movement and penetration of a snack through the orifices for enjoyment by the infant. The instant invention has been shown and described in what it considers to be the most practical and preferred embodiments. It is recognized, however, that departures may be made there from within the scope of the invention and that obvious modifications will occur to a person skilled in the art.

What is claimed is:

1. A multi use pacifier comprising:
a. a teething ring, where the teething ring includes a twist top;
b. a nipple, where the nipple includes a plurality of orifices over the surface of the nipple;
c. a mouth guard at one end of the nipple;
d. a receiver extending beyond the mouth guard, where the twist top attaches the ring to the pacifier;
e. an opening in the receiver for inserting a food product; and
f. safety tabs, where the safety tabs lock the teething ring to the nipple.

2. The multi use pacifier according to claim 1 where the safety tabs are placed on each side of the receiver.

3. The multi use pacifier according to claim 1, where the receiver includes an opening that is used to insert food into the receiver and passed through to the interior of the nipple.

4. The multi use pacifier according to claim 1, where the nipple includes a first end and tabs are provided at the first end to prevent retraction of food out of the nipple near the mouth guard.
